(19) United States
(12) Patent Application Publication
(10) Pub. No.: US 2011/0248028 A1
(43) Pub. Date: Oct. 13, 2011

(54) CERAMIC DISCHARGE VESSEL FOR A HIGH-PRESSURE DISCHARGE LAMP

(75) Inventors: Roland Huettinger, Kaufering (DE); Stefan Juengst, Zorneding (DE); Andreas Kloss, Neubiberg (DE); Steffen Walter, Oberpframmern (DE)

(73) Assignee: OSRAM GESELLSCHAFT MIT BESCHRAENKTER HAFTUNG, Muenchen (DE)

(21) Appl. No.: 13/140,443

(22) PCT Filed: Nov. 11, 2009
(86) PCT No.: PCT/EP2009/064961

§ 371 Date: Jun. 17, 2011

(30) Foreign Application Priority Data
Dec. 18, 2008 (DE) 10 2008 063 620.7

(51) Int. Cl. H01J 61/30

(52) U.S. Cl. 220/2.1 R

(57) ABSTRACT

In various embodiments, a discharge vessel for a high-pressure discharge lamp may include a plurality of parts from ceramic material, wherein the discharge vessel is made of at least two stacked layers.

### TECHNICAL FIELD

The invention relates to a ceramic discharge vessel for a high-pressure discharge lamp according to the preamble of claim 1.

### PRIOR ART

Known from U.S. Pat. No. 6,620,272 is a multi-part ceramic discharge vessel. The individual sections are arranged axially in series.

Known from EP 887 838 is a lamp in which a part of the discharge vessel is produced by means of multilayer technology.

### SUMMARY OF THE INVENTION

The object of the present invention is to provide a ceramic discharge vessel for a high-pressure discharge lamp which can be produced inexpensively.

This object is achieved by the characterizing features of claim 1.

Particularly advantageous embodiments may be found in the dependent claims.

The novel discharge vessel according to the invention is preferably suitable for low-wattage lamps in the range 2 to 100 W, preferably 35 W at the most.

According to the prior art, ceramic hollow bodies for the discharge vessel are produced, for example, by low-pressure injection into a suitable mold. Two half shells produced in this way, i.e. which are arranged axially in series, are welded green to each other and then sintered gas-tight. The electrode systems are melt-sealed with glass solder into ends after the filling has been introduced into the discharge volume. The electrodes are made of tungsten.

The novel discharge vessel for a high-pressure discharge lamp is produced in a plurality of parts from ceramic material, wherein the discharge vessel is made of at least two stacked layers.

Preferably, at least three layers are used, wherein the layers are planar.

Preferably, the discharge vessel includes a full-covering first and last layer embodied in a disk shape, preferably rectangular or rounded or beveled.

Preferably, at least one intermediate layer is embodied substantially circular with a disk-shaped outer contour including a hollow space. Particularly preferably, at least two, in particular three intermediate layers of this kind are present. Alternatively, the intermediate layer is embodied as a rectangular frame.

Typically, the discharge vessel is equipped with electrodes. One or two electrodes can be used. Hereby, these can be embodied as a full-covering layer, preferably made of LaB6.

Preferably, the electrode has a substantially triangular or wedge-shaped embodiment.

Hereby, preferably the hollow space of the intermediate layer is part of the discharge volume.

In addition, advantageously at least one layer has a terminal recess. Preferably, in the case of three intermediate layers, the middle layer has two opposing identical recesses. These are above all intended for electrodes. The electrodes are fitted in the recesses in such a way that they are electrically accessible from the outside.

Reliable production is achieved if the layers are made up of at least two individual layers. Hereby, production follows the principles of multilayer technology.

Finally, the discharge vessel may include a filling channel which is sealed by means of a high-temperature filler which is known per se or by means of a ceramic stopper.

There are two ways of producing novel, preferably low-wattage discharge vessels: by means of multilayer technology or by means of the injection molding process.

The principles of multilayer technology belong to the prior art. In the case of multilayer technology, the discharge vessel is produced as follows:

The discharge vessel is formed by layering thin foils in stacks.

The discharge vessel hereby consists for example of 5 layers, referred to in the following as segments, which in turn may consist of a plurality of individual layers (2-10 individual layers). Segment 1 and 5 form the top and bottom end surfaces. Segments 2, 3 and 4 are punched out inside and form the internal volume and the lateral termination of the discharge vessel. Segment 3, or generally at least one of the middle segments, also has at least one, preferably two punched-out areas, for introducing the electrodes. In the case of two segments, it is also possible for each to have a punched-out area so that the electrodes fitted therein do not lie parallel to the axis of the discharge vessel, but diagonally thereto.

The individual segments are layered in stacks. There are at least three segments, namely two as the first and last cover layers and at least one intermediate layer.

Segment 1 may be considered to be a base plate, which generally includes 2-10 individual layers. The intermediate layers are for example:

Segment 2: the part of the discharge vessel surrounding a hollow space which is part of the discharge volume. Once again, this segment includes 2-10 individual layers. Hereby, the future interior of the discharge vessel is most simply punched out of the complete surface.

Segment 3: is formed similarly to segment 2. In addition, it can have one or two recesses intended for the electrode. Preferably, a LaB6-electrode is used in this recess.

Preferably, the discharge vessel includes a fourth segment similar to the 2nd segment. Segment 4 is also formed from 2-10 individual layers and, once again, the interior is punched out. The cavities of segment 2, 3 and 4 together form the discharge volume.

Preferably, the outer wall of segment 4 contains a recess for simplified electrode contacts on the outer side of the electrode. An external power supply can hence be attached to the outer end of the electrode in a simple way.

The last segment in this embodiment is segment 5. This serves as a sort of cover plate and also includes 2-10 individual layers. This segment also includes a recess for electrode contacts on the outer side.

One special feature, which is also inventive in its own right, relates to the electrodes, which are preferably made not of tungsten but of LaB₆. They can also be produced using film technology and are preferably punched out in a wedge-shape. These wedge-shaped LaB6 electrodes are placed in the recesses of segment 3 and finally laminated together with segments 4 and 5.

This method may be used to produce larger panels (4-6 inches) including a plurality of individual discharge vessels or segments. Following this, the panels are isolated, debinded and sintered.

Alternatively, it is also possible to use an injection molding process to produce the discharge vessel from two segments. The principles of the injection molding process belong to the prior art, see, for example, US-A 2006061138.

Hereby, each of the two segments can be produced using the injection molding process. In principle, hereby each segment is a boat-shaped half-shell. Hereby, for example, the first half-shell advantageously contains recesses for the electrodes, which here, once again, are preferably made of LaB6. Finally, following the insertion of the electrodes, the two half-shells are laminated to form a discharge vessel. The debinding and sintering of the molded bodies are then the final procedures.

### BRIEF DESCRIPTION OF THE DRAWINGS

The following will now explain the invention in more detail with reference to an exemplary embodiment. The drawings show:

FIG. 1 a novel discharge vessel with four layers

FIG. 2 a novel discharge vessel with five layers

FIG. 3 different views of the discharge vessel from the side (3a), from the side rotated by 90° (3b) and from above (3c).

### PREFERRED EMBODIMENTS OF THE INVENTION

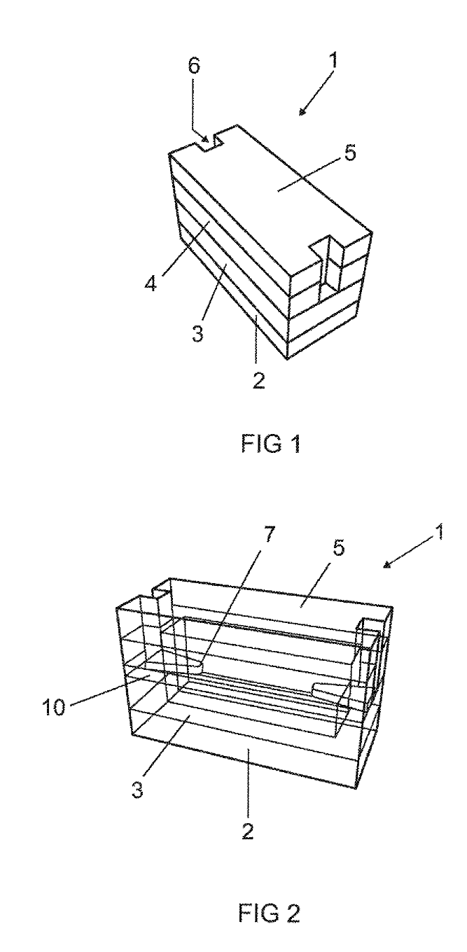

FIG. 1 shows a novel discharge vessel 1 including four segments, which is in particular intended for low-wattage lamps in the range of 2 to 20 W. It includes a first segment 2 as a rectangular base plate. Obviously, this plate can also be oval, circular, elliptic or rounded or beveled in some other way in order, for example, ultimately to provide a discharge vessel which is as isothermal as possible. Placed on this, there is a second segment 3, which has the same outer contour as segment 1, although this is not absolutely necessary. However, the second segment is hollow, so that, viewed on its own, it resembles a ring or a hose with rectangular distortion. In the case of a rectangular embodiment, the second segment may have a recess for every electrode on its narrow sides. This recess is matched to the embodiment of the electrode. Since the electrode is also embodied flat as a layer, but is made of different material such as LaB6, it fits exactly into the recess.

A third segment 4 is seated on the second segment 3. In the case of a rectangular embodiment, it may have a recess for each electrode on its narrow sides. This recess is matched to the embodiment of the electrode. Since the electrode is also embodied flat as a layer, but is made of different material such as LaB6, it fits exactly into the recess.

A fourth segment 5 with the same outer contour is seated on the third segment 4. It has a rectangular embodiment and a channel-like recess 6, which is preferably embodied so that it leaves a part of the surface of the electrode 7 free. However, it should cover another part of the electrode as this provides its mounting and sealing. This channel-like recess is substantially rectangular or cuboid. It is present on both narrow sides.

FIG. 2 shows a similar discharge vessel, only here the discharge vessel is made of five layers.

Seated on the last intermediate segment, there is a terminating segment 5, which also substantially has the same outer contour. Here, it functions as a cover plate and is hence the last segment. However, it is equipped with the same or similar recesses as in the case with segment 4 so that the channel-like recesses lie one on top of the other and hence provide simple access to the exposed surface of the electrode. This enables a power supply to be attached to this exposed surface of the surface the electrode in a simple way.

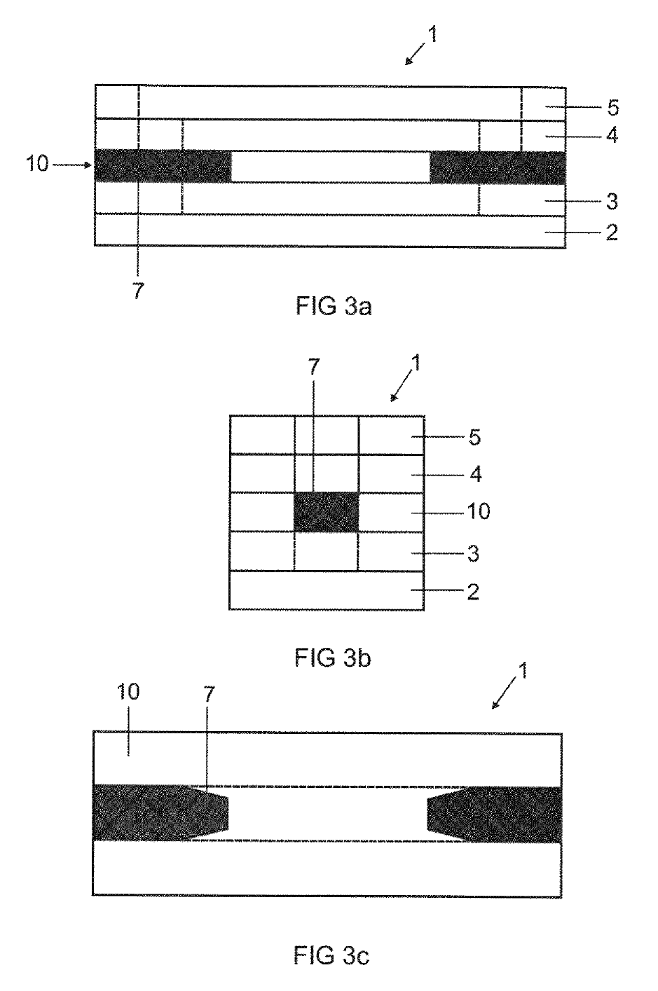

FIG. 3 shows in detail the structure of the discharge vessel according to FIG. 2. Hereby, the two base or cover plates 2 and 5 enclose three intermediate layers 3, 10, 4, of which the middle ones include the two electrodes 7 made of LaB6 in the middle of their narrow sides.

Production is achieved in that, initially, the individual layers are combined to form segments which are punched to the appropriate form, and then the individual segments are connected in sequence, wherein the electrodes are sintered in directly. Hereby, the individual layers are prelaminated into segments and finally, in a further step, the segments are finish-laminated to produce a module.

Exemplary outer dimensions of the discharge vessel are:

The layers or segments have a thickness of 0.2 mm and the electrode (segment 3) has a thickness of 0.1 mm. The overall height is hence 0.9 mm. The three internal intermediate layers have a circumferential wall thickness of 1.5 mm. The internal base area of the discharge volume is 0.5×5.5 mm². The internal height of the discharge vessel works out at 0.5 mm. This results in a dimension of 0.5 mm×0.5 mm×5.5 mm for the discharge volume. The internal surface is 11.0 mm². With a wall thickness of 1.5 mm, the external dimensions of the discharge vessel are:
dimensions: 0.9 mm×3.5 mm×8.5 mm
external surface: 81.1 mm².

The power emitted by the discharge vessel is temperature-dependent. This is:
at 1300 K about 2.82 W;
at 1400 K about 3.53 W.

The coated ceramic discharge vessel preferably substantially includes Al203, or also other known oxides, nitrides, or oxinitrides, preferably aluminum, or also Dy or Y. In particular, PCA is used, hereby this can contain the usual doping additives, such as MgO.

Preferably, a novel electrode is also used in conjunction with the novel discharge vessel. This is completely novel with respect to its embodiment and the type of sealing. As a result, the emphasis falls more on other material properties than is usually the case, namely optimum adaption to the production process for the discharge vessel. Here, LaB6 has been found to be very suitable as the material for the electrode. This is the exact opposite of the material previously exclusively used in this context, tungsten.

The most important parameters of LaB6 are compared to those of tungsten in Table 1.

TABLE 1
Comparison of important parameters for LaB₆ and tungsten

| | Tungsten | LaB₆ |
|---|---|---|
| Melting point/K | 3600 | 2528 |
| Work function/eV | 4.55 | 2.41 |
| Thermal conductivity/ | 170 | 47 |
| Wm⁻¹K⁻¹ | | |
| Coefficient of thermal | 4.7 | 6.2 (PCA = 8.3) |
| expansion 10⁻⁶K⁻¹ | | |

The work function of LaB6 which is about 2 eV lower results in an electrode temperature which is about 1300 K lower than that of conventional tungsten electrodes. This results in evaporation rates comparable to those with tungsten but, due to the lower thermal conductivity and lower operating temperature, results in much lower thermal losses. Due to its coefficient of thermal expansion, LaB₆ is much better adapted to PCA (8.3×10⁻⁶ K⁻¹) than tungsten.

A coefficient of thermal expansion of this kind, which is better adapted to PCA, enables direct sintering into PCA and avoids complex electrode bushing structures such as those required for current PCA discharge vessels.

Preferably, LaB6 is used for the electrode. Alternatively, it is also possible to use other ceramics made of carbides, nitrides or borides of high-melting metals, such as, e.g., TaC, HfC, CeB₆, GdB₆, W2B5, MoB2, ZrN.

The preferably trapezoidal or triangular electrodes have, for example, a thickness of 0.1 mm and are, for example, in the case of a trapezoidal shape 0.3 mm wide at the back and 0.12 mm wide at the front.

An electrode insertion depth of 1.25 mm into the discharge vessel results in an electrode spacing of 3 mm and, depending on the filling, a lamp wattage of 2 to 20 W.

There are various options for the evacuation and filling of the discharge vessel. The following three embodiments are preferred:
1. Seen overall, a filling channel is provided in segment 2, 3 and/or 4, which is sealed after filling e.g. with hot solder. Technology of this kind is known in principle, it is also possible to use what is known as a stopper, see WO 94/18693.
2. A filling channel is subsequently introduced into the ready-sintered discharge vessel, for example by means of laser technology and the filling channel is sealed after filling, e.g. with hot solder or a stopper.
3. The filling channel is introduced in the region of the recess in the electrode or the electrode itself includes a filling channel, but this is not positioned in the region of the tip, but on the side.

Compared to known ceramic discharge vessels, the novel discharge vessel has a much shorter overall length, which is only possible due to its completely different design.

Suitable fillings are known per se. Preferably, a metal halogenide filling is used, as is known per se. However, it is also possible to implement high-pressure mercury vapor lamps or sodium vapor lamps and Hg-free lamps with this method.

In principle, the electrodes may also constitute a whole side surface of an intermediate layer. Hereby, the frontage can be provided with a shielding coating and only the actual electrode in the middle can be free of the covering layer.

In principle, all the layers can be produced with either multilayer technology or injection molding technology. The combined use of the two technologies is also possible.

Substantial features of the invention in form of a numbered list are:
1. A discharge vessel for a high-pressure discharge lamp produced in a plurality of parts from ceramic material, characterized in that the discharge vessel is made of at least two stacked layers.
2. The discharge vessel as claimed in claim 1, characterized in that at least three layers are used, wherein the layers are planar.
3. The discharge vessel as claimed in claim 1, characterized in that the discharge vessel includes a full-covering first and last layer embodied in a disk shape, preferably rectangular or rounded.
4. The discharge vessel as claimed in claim 1, characterized in that at least one intermediate layer is embodied substantially circular with a disk shaped outer contour encompassing a hollow space.
5. The discharge vessel as claimed in claim 4, characterized in that at least two intermediate layers of this kind are present.
6. The discharge vessel as claimed in claim 1, characterized in that the discharge vessel is equipped with electrodes.
7. The discharge vessel as claimed in claim 6, characterized in that at least one electrode is embodied as a full-covering layer, which is preferably made of LaB6, TaC, HfC, CeB₆, GdB⁶, W2B5, MoB2 or ZrN.
8. The discharge vessel as claimed in claim 6, characterized in that the electrode has a substantially triangular or trapezoidal cross-sectional area, wherein the narrow tip in particular protrudes into the discharge vessel.
9. The discharge vessel as claimed in claim 4, characterized in that the hollow space is part of the discharge volume.
10. The discharge vessel as claimed in claim 1, characterized in that at least one layer has a terminal recess.
11. The discharge vessel as claimed in claim 1, characterized in that the layers are made up of at least two partial layers or individual layers.
12. The discharge vessel as claimed in claim 10, characterized in that at least two adjacent stacked layers have an identical recess.
13. The discharge vessel as claimed in claim 1, characterized in that the discharge vessel includes a filling channel sealed by means of solder or a stopper.

1. A discharge vessel for a high-pressure discharge lamp, comprising:
a plurality of parts from ceramic material,
wherein the discharge vessel comprises at least two stacked layers.

2. The discharge vessel as claimed in claim 1,
wherein at least three layers are used,
wherein the layers are planar.

3. The discharge vessel as claimed in claim 1,
wherein the discharge vessel comprises a full-covering first and last layer embodied in a disk shape.

4. The discharge vessel as claimed in claim 1,
wherein at least one intermediate layer is embodied substantially circular with a disk shaped outer contour encompassing a hollow space.

5. The discharge vessel as claimed in claim 4,
wherein at least two intermediate layers of this kind are present.

6. The discharge vessel as claimed in claim 1,
wherein the discharge vessel is equipped with electrodes.

7. The discharge vessel as claimed in claim 6,
wherein at least one electrode is embodied as a full-covering layer.

8. The discharge vessel as claimed in claim 6,
wherein the electrode has a substantially triangular or trapezoidal cross-sectional area.

9. The discharge vessel as claimed in claim 4,
wherein the hollow space is part of the discharge volume.

10. The discharge vessel as claimed in claim 1,
wherein at least one layer has a terminal recess.

11. The discharge vessel as claimed in claim 1,
wherein the layers are made up of at least two partial layers or individual layers.

12. The discharge vessel as claimed in claim 10,
wherein at least two adjacent stacked layers have an identical recess.

13. The discharge vessel as claimed in claim 1,
wherein the discharge vessel comprises a filling channel sealed by means of solder or a stopper.

14. The discharge vessel as claimed in claim 3,
wherein the discharge vessel comprises a full-covering first and last layer embodied in a disk shape, rectangular or rounded.

15. The discharge vessel as claimed in claim 7,
wherein the full-covering layer is made of a material selected from a group consisting of: LaB6, TaC, HfC, CeB₆, GdB₆, W2B5, MoB2; and ZrN.

16. The discharge vessel as claimed in claim 8,
wherein the narrow tip protrudes into the discharge vessel.
